(19) United States
(12) Patent Application Publication
(10) Pub. No.: US 2026/0229215 A1
(43) Pub. Date: Aug. 6, 2026

(54) PROVIDING ACCESSIBILITY TO VISUALLY IMPAIRED USERS OF DYNAMIC APPLICATIONS

(71) Applicant: Cisco Technology, Inc., San Jose, CA (US)

(72) Inventors: David C. White, JR., St. Petersburg, FL (US); Mohammed Izzat Hamzeh, Van Alstyne, TX (US)

(73) Assignee: Cisco Technology, Inc., San Jose, CA (US)

(21) Appl. No.: 19/042,139

(22) Filed: Jan. 31, 2025

(51) Int. Cl. G10L 13/02; G09B 21/00

(52) U.S. Cl. CPC G10L 13/02; G09B 21/001

(57) ABSTRACT

In one implementation, a device obtains a captured image of application data displayed by an application to a user via an electronic display of an endpoint operated by the user. The device generates a prompt for input to a generative artificial intelligence model that asks the generative artificial intelligence model to summarize the captured image. The device sends the prompt to the generative artificial intelligence model, to generate a summary of the captured image. The device causes the endpoint operated by the user to read the summary of the captured image to the user.

### TECHNICAL FIELD

The present disclosure relates generally to providing accessibility to visually impaired users of dynamic applications.

### BACKGROUND

Today, visually impaired people are challenged with navigating computer screens. They largely depend on “Job Access With Speech” (JAWS) to navigate and read applications. While helpful, JAWS and other existing accessibility tools do not perform well with web pages that create dynamic content or interactive visuals. For example, consider the case of a user interface that allows a user to review the topology of a computer network, such as by zooming in on a given city, branch, building, or node. Such a user interface is difficult to describe via JAWS or other screen readers.

Many accessibility applications rely on websites adding in accessibility features to assist visually impaired people to use a given website. In other words, JAWS and other accessibility applications are only able to afford accessibility to those users if the websites are specifically configured with additional information. Unfortunately, this often does not happen due to a lack of resources of the website developer, a lack of knowledge of accessibility standards, and other factors. Furthermore, even with these functions implemented into the website, doing so only aids a visually impaired person in understanding what the website is presenting. Interacting with the website, though, still remains a challenge for the visually impaired user.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example of a user interfacing with a generative model;

FIG. 4 illustrates an example architecture for an artificial intelligence (AI) agent;

FIG. 5 illustrates an example of a dynamic application;

FIGS. 6A-6E illustrates an example of an interactive workflow in a dynamic application;

FIG. 7 illustrates an example of an architecture for providing accessibility to visually impaired users of dynamic applications;

FIG. 8 illustrates an example flow diagram for providing accessibility to visually impaired users of dynamic applications; and

FIG. 9 illustrates an example simplified procedure for providing accessibility to visually impaired users of dynamic applications, in accordance with one or more implementations described herein.

### DESCRIPTION OF EXAMPLE IMPLEMENTATIONS

### Overview

According to one or more implementations of the disclosure, a device obtains a captured image of application data displayed by an application to a user via an electronic display of an endpoint operated by the user. The device generates a prompt for input to a generative artificial intelligence model that asks the generative artificial intelligence model to summarize the captured image. The device sends the prompt to the generative artificial intelligence model, to generate a summary of the captured image. The device causes the endpoint operated by the user to read the summary of the captured image to the user.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

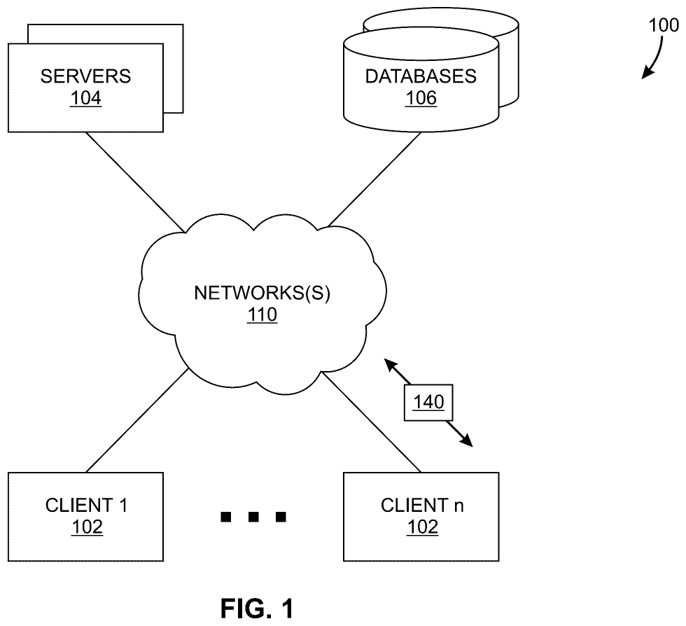

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

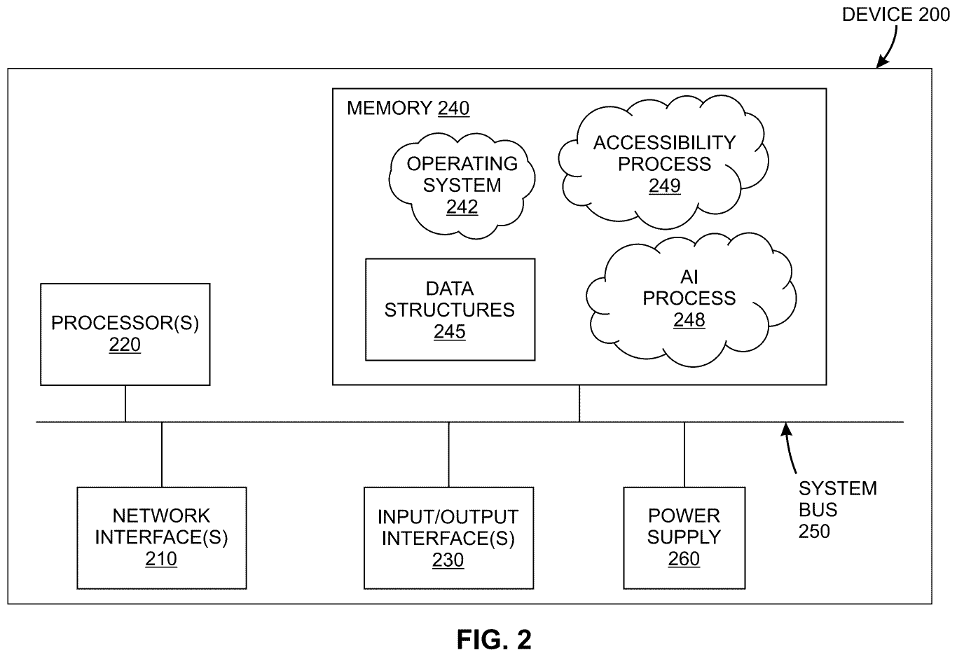

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise an AI process 248 and/or an accessibility process 249, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, AI process 248 and/or accessibility process 249 may include computer executable instructions that, when executed by processor 220, cause device 200 to perform the techniques described herein. To do so, in some implementations, AI process 248 and/or accessibility process 249 may utilize AI/machine learning. In general, AI/machine learning is concerned with the design and the development of techniques that take as input empirical data (such as network statistics and performance indicators) and recognize complex patterns in these data. One very common pattern among these techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, AI process 248 and/or accessibility process 249 may use one or more supervised, unsupervised, or semi-supervised AI/machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example AI/machine learning techniques that AI process 248 and/or accessibility process 249 could use may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, AI process 248 and/or accessibility process 249 may also use one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of machine unlearning, AI process 248 may be a component of, use, and/or be utilized in the management of prompts/access to a generative model to perform layer attribution, perform layer sensitivity assessment, remove capabilities from a previously trained model, retain model performance, etc. based on a conversational input from a user (e.g., voice, text, etc.). Example generative approaches can include, but are not limited to, generative adversarial networks (GANs), large language models (LLMs) and other foundation models, diffusion models, transformer models, and the like.

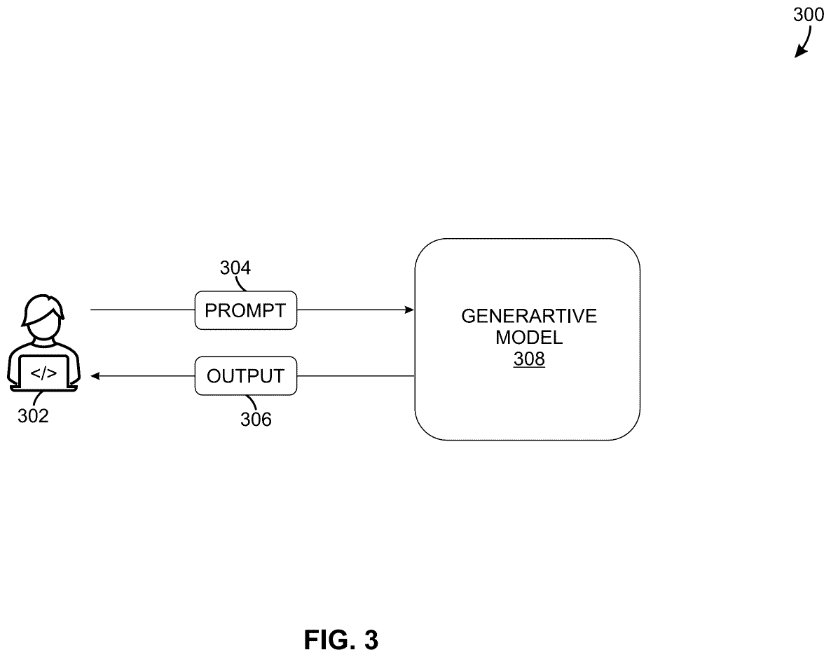

FIG. 3 illustrates an example 300 for interfacing with a generative model, in various implementations. In example 300, a user 302 may send a prompt 304 (e.g., a query, a query augmented with additional data, documents, and/or images, etc.) to a generative model 308. The generative model 308 may be configured to process a prompt 304 to generate an output 306 to satisfy the prompt 304.

The generative model 308 may be a model configured to apply its trained algorithms to generate a response (e.g., output 306) based on the prompt 304 provided. For instance, in some cases, generative model 308 may take the form of a large language model (LLM) or other foundation model, diffusion-based model, combinations thereof, or the like.

The output 306 may be the result produced by the generative model 308 (e.g., by the application of the generative model 308 to the prompt 304). This output can vary depending on the model's configuration and the task at hand. For example, the output 306 may include one or more of a generated and/or synthesized image, a text response, a classification and/or prediction, etc.

As would be appreciated, AI agents are also capable of interacting with generative models, such as generative model 308, which may be integrated directly into the agent or accessed via an API. Indeed, the recent breakthroughs in large language models (LLMs), such as GPT-4, as well as other generative models, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

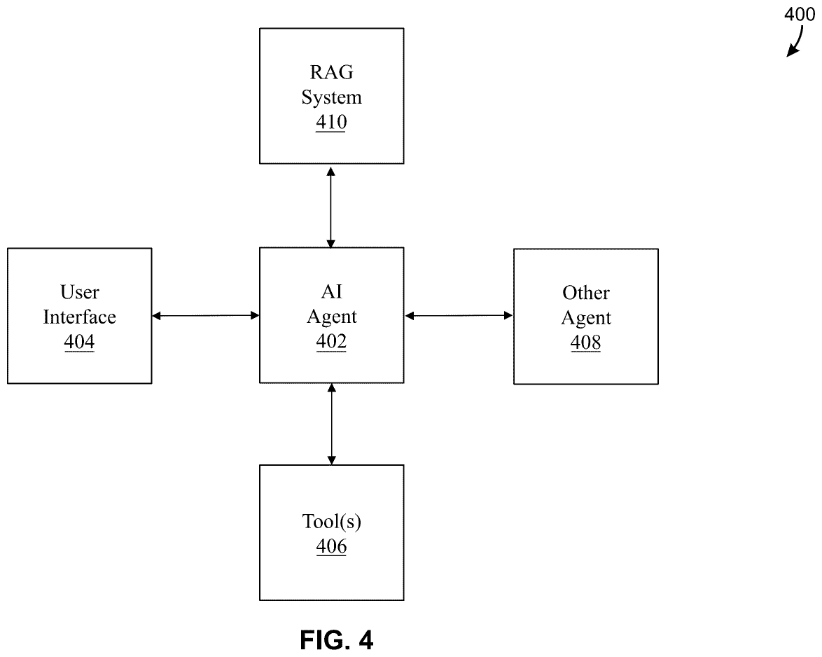

FIG. 4 illustrates an example architecture 400 for an artificial intelligence (AI) agent, according to various implementations. At the core of architecture 400 is AI agent 402, which may be implemented through execution of AI process 248.

As shown, AI agent 402 may interact with a user via a user interface 404. For instance, a user may issue a prompt to AI agent 402 that seeks an answer to a question, performance of a certain task, or the like. In turn, AI agent 402 may use its associated model to formulate a response.

Also as shown, AI agent 402 may interact with tools 406. In general, tools 406 may take the form of interfaces that allow AI agent 402 to interact with any number of systems, in its efforts to produce a response for its input request. For instance, tools 406 may allow AI agent 402 to perform searches (e.g., web searches, searches within a given application or database, etc.), send control commands, or perform other actions, as needed.

In various implementations, AI agent 402 may also be part of an agentic system whereby multiple AI agents interact with one another to formulate a response to an input request. Indeed, the tools, models, etc. available to any given agent may differ across the agentic system. Consequently, different agents may have different capabilities and specialties. Thus, in some implementations, AI agent 402 may also interact with other agent 408, to aid in formulating a final response to its input request. Typically, other agent 408 is executed by a different device than that of the device execution AI agent 402, meaning that AI agent 402 and other agent 408 may communicate via a computer network. In other implementations, though, both agents may be executed by the same device, in further implementations.

For instance, assume that other agent 408 uses a model that has be specialized using knowledge about computer networks and interfaces with tools capable of interacting with a computer network (e.g., to retrieve information, make configuration changes, etc.). Now, assume that the user of user interface 404 issues a query to AI agent 402 asking why the performance of their videoconferencing application is poor. Further, assume that AI agent 402 uses a model that has been specialized on knowledge about the videoconferencing application and able to interact with that application via tools 406. If its initial assessment of the operation of the videoconferencing application is that everything appears to be performing well at the server level, AI agent 402 may then issue a request to other agent 408, to see whether the root cause of the poor performance is the computer network itself.

In some implementations, AI agent 402 may also interact with, or include, a retrieval augmented generation (RAG) system, such as RAG system 410. In general, RAG systems operate by enhancing a prompt for input to a generative model (e.g., an LLM) with additional context. Typically, underlying a RAG system is a dataset of documents or other information that is in a particular domain. For instance, consider the case of AI agent 402 generating a prompt that asks its LLM to make an assessment regarding a computer network. In the case of a general LLM, the LLM may not have specialized knowledge regarding the devices in the network (e.g., command line interface commands, information about the topology of the network, etc.). In such a case, RAG system 410 may modify the prompt, prior to input to the LLM, to provide this additional context, thereby improving the quality of the response and avoiding hallucinations. Typically, a RAG system stores this contextual information in a vector database for quick retrieval using semantic searching.

As noted above, visually impaired people are challenged with navigating computer screens. They largely depend on “Job Access With Speech” (JAWS) to navigate and read applications. While helpful, JAWS and other existing accessibility tools do not perform well with web pages that create dynamic content or interactive visuals. For example, consider the case of a user interface that allows a user to review the topology of a computer network, such as by zooming in on a given city, branch, building, or node. Such a user interface is difficult to describe via JAWS or other screen readers.

Many accessibility applications rely on websites adding in accessibility features to assist visually impaired people to use a given website. In other words, JAWS and other accessibility applications are only able to afford accessibility to those users if the websites are specifically configured with additional information. Unfortunately, this often does not happen due to a lack of resources of the website developer, a lack of knowledge of accessibility standards, and other factors. Furthermore, even with these functions implemented into the website, doing so only aids a visually impaired person in understanding what the website is presenting.

Interacting with the website, though, still remains a challenge for the visually impaired user. More specifically, current state-of-the-art screen readers “read” the text on a webpage by leveraging accessibility text embedded in the page. They operate in two modes: document mode and application mode. Document mode is for “reading” and application mode is for capturing the input and applying it to forms and fields. Users navigate with a keyboard instead of the mouse, as they typically cannot see the mouse cursor, and are guided by audible instructions. With such screen readers, well-structured and labeled pages are vital to allowing understanding of the information on the page. Most screen readers in document mode cache the page first in order to analyze it, though, and dynamic content causes these cached pages to become stale, causing them to output incorrect content to the user.

### Providing Accessibility to Visually Impaired Users of Dynamic Applications

The techniques herein provide accessibility to visually impaired users of dynamic applications, such as webpages that include dynamic content. In some aspects, the techniques herein do so by capturing images of the dynamic application and sending them for analysis. Such analysis may include deduplication and detecting significant images (e.g., by identifying material and non-material changes over time). The result of this analysis is a set of meaningful images that the system sends to a generative AI model to describe. The output of the model is then provided back to the user interface for presentation to the user (e.g., by reading the description to the user).

Illustratively, the techniques described herein may be performed by hardware, software, and/or firmware, such through execution of accessibility process 249, which may include computer executable instructions executed by the processor 220 (or independent processor of interfaces 210) to perform functions relating to the techniques described herein, e.g., in conjunction with AI process 248.

Specifically, according to various implementations, a device obtains a captured image of application data displayed by an application to a user via an electronic display of an endpoint operated by the user. The device generates a prompt for input to a generative artificial intelligence model that asks the generative artificial intelligence model to summarize the captured image. The device sends the prompt to the generative artificial intelligence model, to generate a summary of the captured image. The device causes the endpoint operated by the user to read the summary of the captured image to the user.

Operationally, the techniques herein introduce an accessibility system that is able to read, see, and interpret dynamic applications, such as webpages with dynamic content, thereby allowing a visually impaired user to dynamically interact with the application almost as easily as visually unimpaired user.

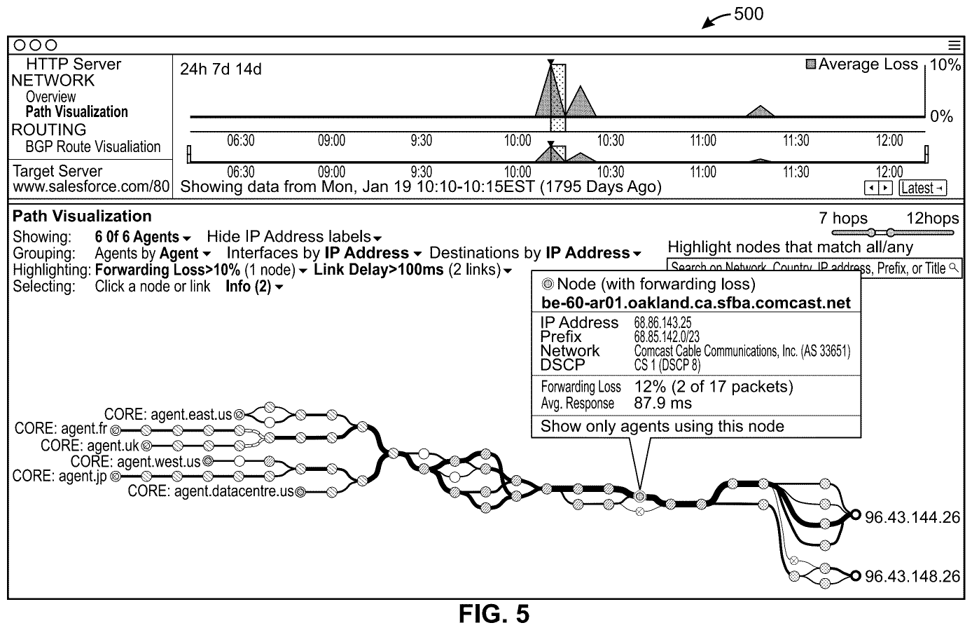

By way of example, many network vendors such as Cisco Systems, Inc., use dynamic applications to represent the topology of a computer network to a user. For instance, FIG. 5 illustrates an example 500 of such a dynamic application. As shown, the dynamic application may take the form of a webpage that allows a user to interact with the displayed content, such as to zoom in on an area of the network topology. In other cases, the dynamic application may include an AI assistant that allows a user to chat with the system to dynamically view the network topology of flows and the various statuses of each segment or device.

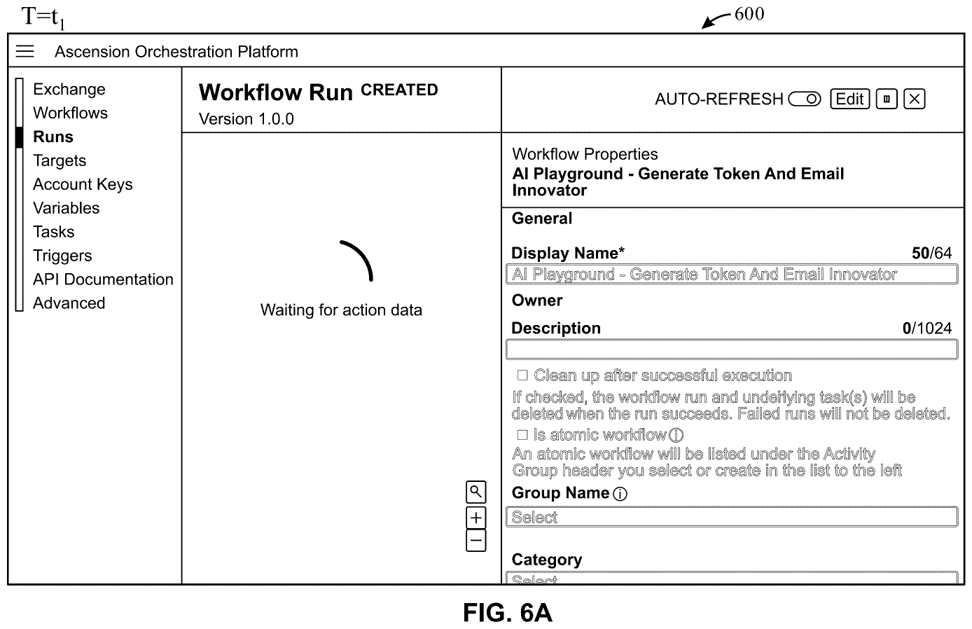

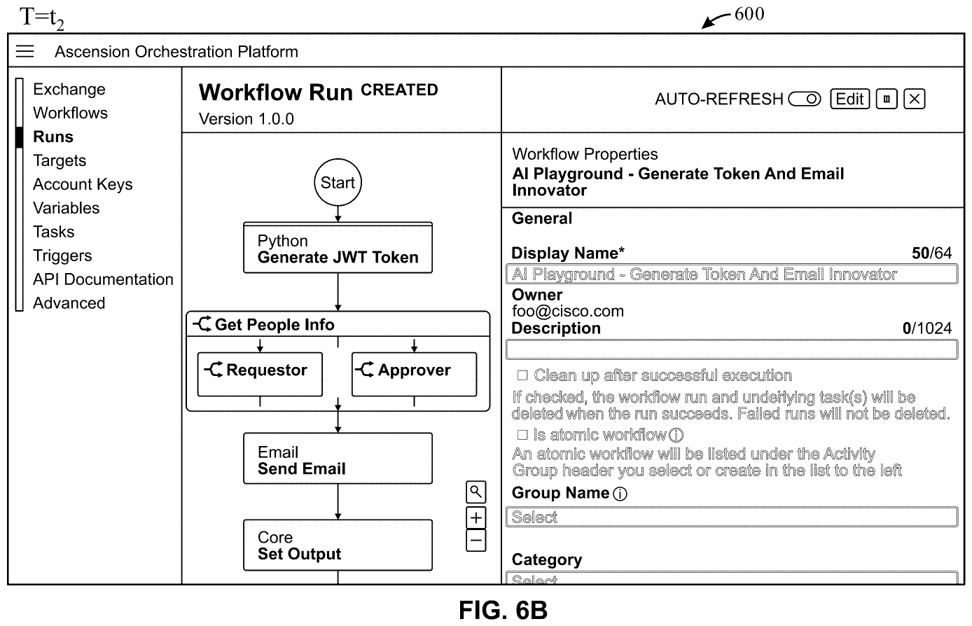

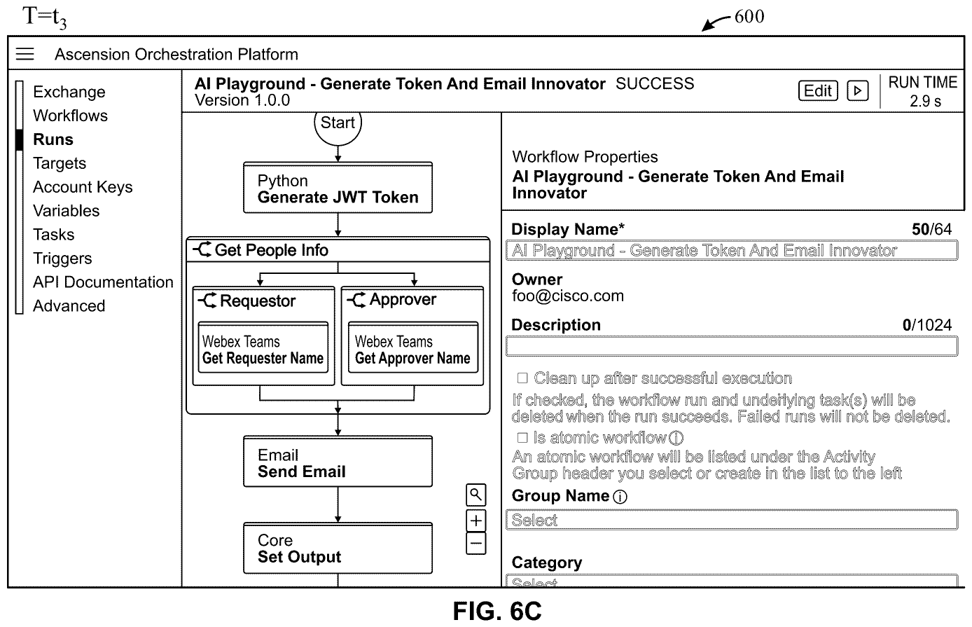

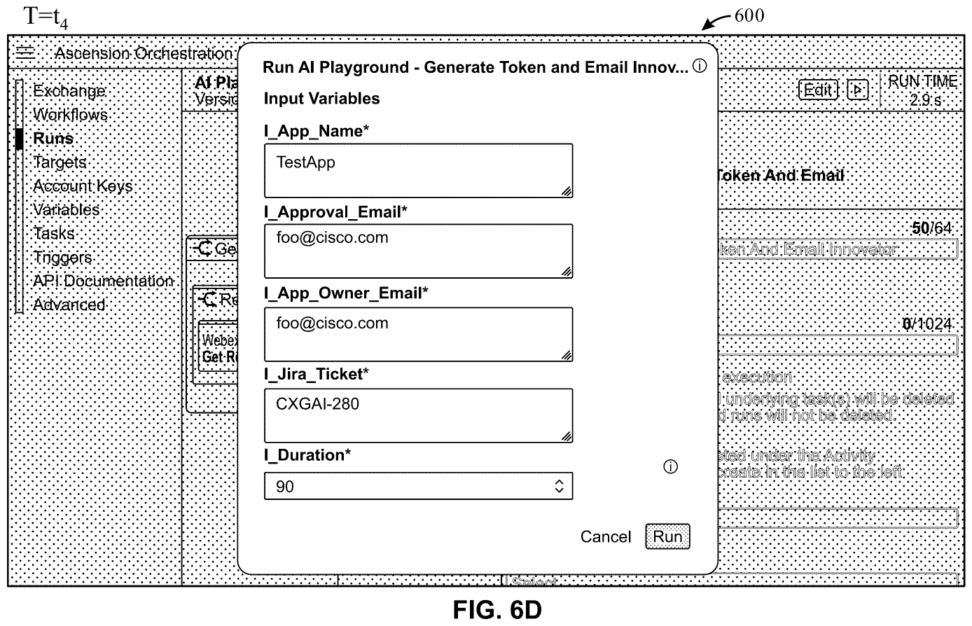

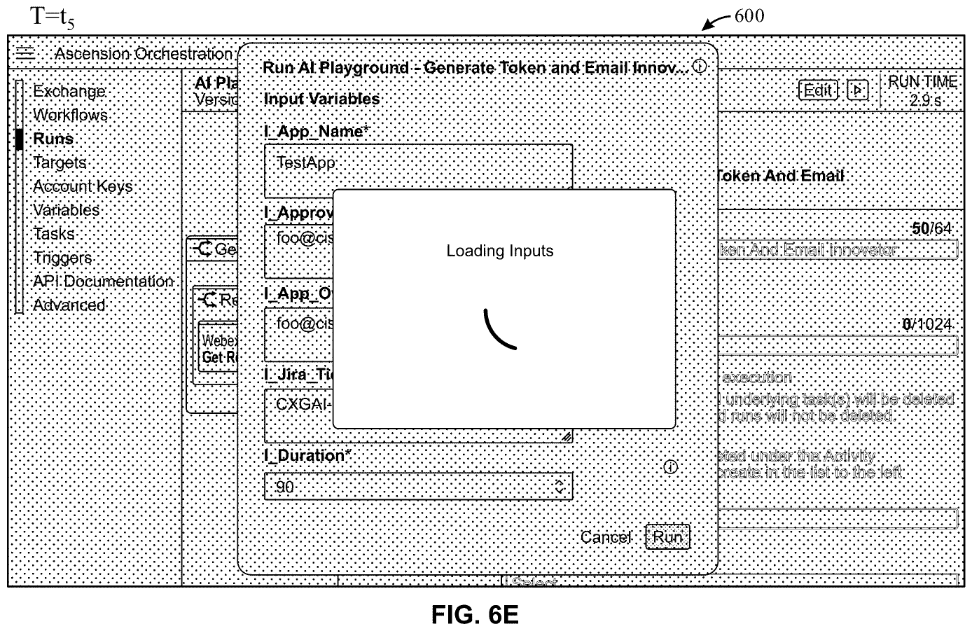

Another example of a dynamic application is shown in FIGS. 6A-6E, which illustrate an interactive workflow within a dynamic application, in various implementations. As shown, the execution of the workflow may progress from time T=T₁ in FIG. 6A, to time T=T₂ in FIG. 6B, to time T=T₃ in FIG. 6C, to time T=T₄ in FIG. 6D, and finally to time T=T₅ in FIG. 6E.

Understanding where a workflow, such as the workflow shown in FIGS. 6A-6E, is (in the execution) or what failures occurred in the workflow is very challenging for screen readers. Indeed, a traditional screen reader attempts to literally translate the presented text but will fail at translating the imagery or the connectivity between the text and the image.

To address these shortcomings, the techniques herein propose the use of the following:
1. A mechanism that captures images of the dynamic application (e.g., a browser plug-in, an add-on or built-in mechanism of a standalone application with hooks into the operating system for screen recording, etc.).
2. A mechanism that leverages a multi-modal generative AI model (e.g., LLM, etc.) to summarize the captured images. These summaries may then be provided back to the user (e.g., as audio), thereby allowing a visually impaired user a description of the application.

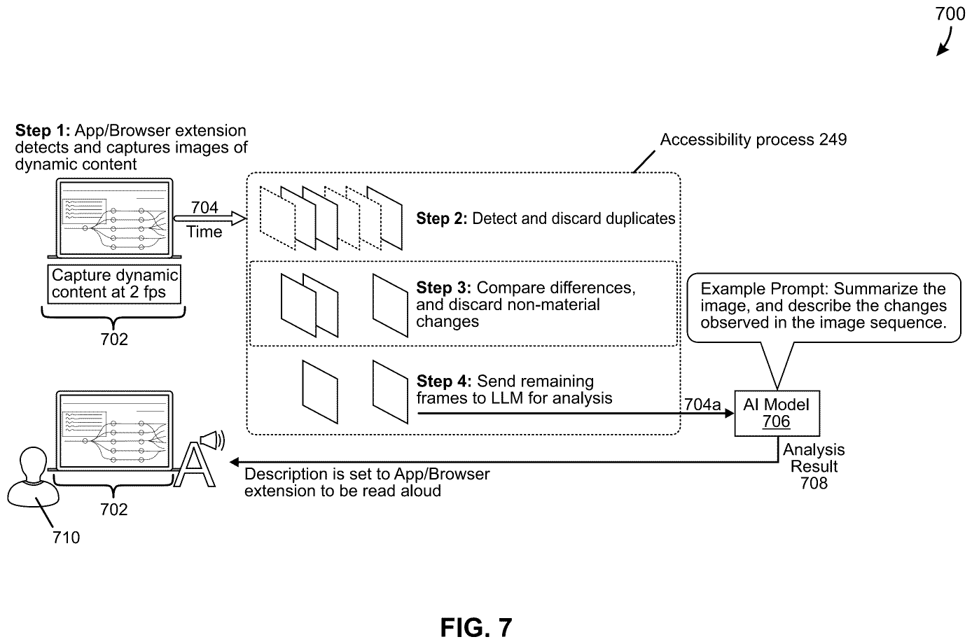

FIG. 7 illustrates an example of an architecture 700 for providing accessibility to visually impaired users of dynamic applications, according to various implementations. At the core of architecture 700 is accessibility process 249, which may be executed on an endpoint device, a networking device, a server, or any other suitable device in communication with a user interface 702. During execution, user interface 702 may present visual content to an end user as part of a dynamic application. For instance, such a dynamic application may take the form of a standalone application, a web browser displaying a webpage with dynamic content, or the like.

In various implementations, user interface 702 may be configured with image capture functionality. For instance, in the case of the dynamic application being presented via a web browser, the web browser may use an image capture add-in to capture images of what user interface 702 displays over time. In other instances, the image capture mechanism may be integrated into the standalone, dynamic application, the operating system of the endpoint device, as an endpoint agent, or the like. In one implementation, the image capture functionality may instead capture a movie or other series of images of the dynamic application over time as images 704. For example, images 704 may take the form of a movie captured over a short period of time and at a lower frame rate that show how the dynamic content of the application is changing/has changed.

As a first step, the image capture mechanism may capture and provide images 704 to accessibility process 249 for analysis. This can be done either on a pull or push basis, as desired. In some implementations, the image capture mechanism may capture and provide images 704 to accessibility process 249 at a predefined frequency. For instance, the image capture mechanism may capture and provide images 704 at a frequency of two frames per second (fps) or any other frequency as desired.

In response to receiving images 704, accessibility process 249 may assess images 704 for any duplicate images, as a second step. More specifically, accessibility process 249 may use a suitable image comparison algorithm (e.g., between consecutive images/frames) to determine whether those images from among images 704 are duplicates. If so, accessibility process 249 may discard any duplicates.

Next, as a third step, accessibility process 249 may compare the differences between the remaining set of the images 704. In turn, accessibility process 249 may determine whether any such differences are considered material. In some implementations, accessibility process 249 may do so by using image recognition to formulate a set of image features for each of the images 704 that it is comparing. For instance, accessibility process 249 may identify different visual effects, text fields, icons, images being presented by the dynamic application, etc. and compare these features across different images from images 704.

In various implementations, accessibility process 249 may deem the images as being materially/significantly different based on one or more of: the number of differing features between them (e.g., if the total number of differing features exceeds a threshold), the type(s) of differing features (e.g., certain types of features may be more important than others), or according to any other criteria as desired. If accessibility process 249 determines that any pair or other set of the images 704 has non-material differences, it may keep one of them and discard the rest, thereby producing processed images 704a.

As a fourth step, accessibility process 249 may then provide processed images 704a to an AI model 706 for summarization. For instance, in some implementations, accessibility process 249 may do so by communicating with AI process 248, which implements an AI agent or other interface to interact with AI model 706. In general, AI model 706 may be a multimodal, generative AI model, such as a multimodal LLM or the like. Such a model may be multimodal, meaning that it may be able to input and/or output data in different formats (e.g., images, audio, text, etc.).

Accordingly, accessibility process 249 (or AI process 248) may formulate an appropriate prompt for AI model 706 that asks AI model 706 to generate a summary of processed images 704a. By way of example, a prompt for AI model 706 may be: “Summarize the image, and describe the changes observed in the image sequence.” Of course, such a prompt is intentionally simplistic for illustrative purposes and additional description and context could also be added (e.g., via a RAG mechanism, etc.). In turn, AI model 706 may generate analysis results 708 that indicate the requested summarization. Note that AI model 706 may not only summarize the current image from processed images 704a but may also maintain a history of processed images 704a, to also summarize the visual changes across those images (e.g., to describe motions, the appearance or disappearance of visual features, etc.).

In turn, accessibility process 249 may provide analysis results 708 back to user interface 702 for presentation to the visually impaired user 710. In one implementation, analysis results 708 may take the form of audio that user interface 702 plays to visually impaired user 710. In another implementation, analysis results 708 may take the form of text that user interface 702, or another intermediate mechanism, converts into audio before playing that audio to visually impaired user 710.

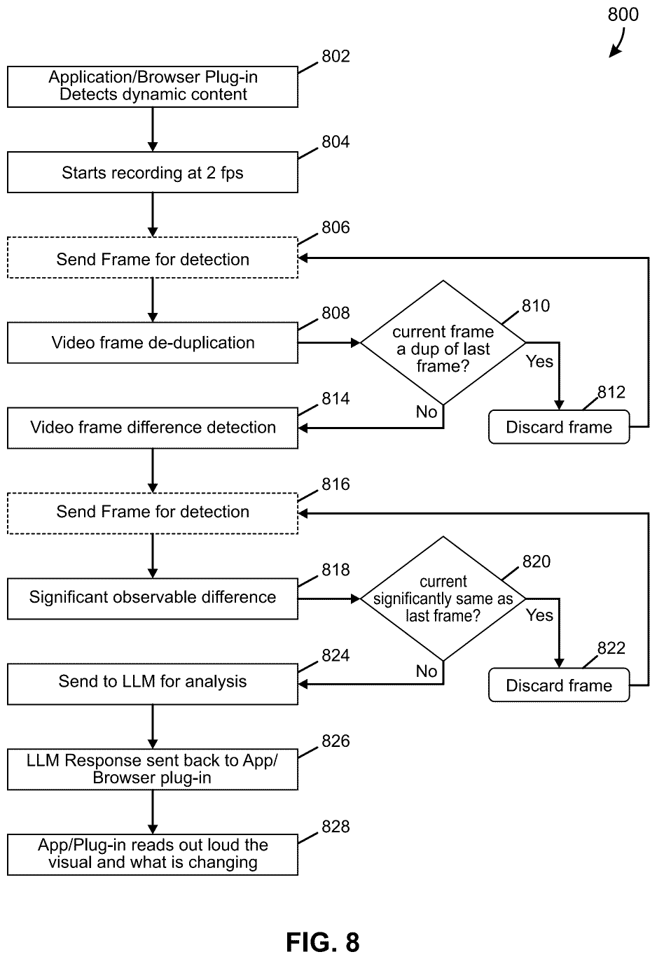

FIG. 8 illustrates an example flow diagram 800 for providing accessibility to visually impaired users of dynamic applications, according to various implementations. In general, flow diagram 800 shows the steps described above with respect to FIG. 7 in greater detail.

As step 802, the application, browser plug-in, or the like, detects dynamic content.

At step 804, the application, browser plug-in, etc. then starts recording images of the user interface at a predefined rate, such as two fps.

At step 806, the application, browser plug-in, etc. sends the image/frame for detection/analysis by accessibility process 249.

At step 808, accessibility process 249 assesses whether any duplicate images/frames exist. To do so, it may, at step 810, make a decision as to whether the current image/frame is a duplicate of the previous image/frame. If so, at step 812, it may discard the current image/frame and await the next frame to be sent at step 806. However, if the current image/frame is not a duplicate, it may proceed to initiate difference detection at step 814.

At step 816, accessibility process 249 may send the current image/frame for difference detection. More specifically, accessibility process 249 may initiate processing at step 818, to determine whether the current image/frame is significantly/materially different from that of prior image(s)/frame(s). To do so, at step 820, it may make a determination as to whether the current image/frame is significantly the same as the prior image/frame. For instance, it may compare the identified features of both and determine whether the two satisfy a predefined threshold to be considered different. If they are not, at step 822, accessibility process 249 may discard the current frame.

If accessibility process 249 determines at step 820 that the current image/frame is different, it may send that frame to an LLM or other generative AI model for analysis at step 822. For instance, accessibility process 249 may cause the image/frame to be sent in conjunction with a prompt to the model that asks the model to summarize the image/frame.

At step 826, accessibility process 249 may then send the response from the LLM or other generative AI model back to the application, browser plug-in, or the like for presentation to the user.

Finally, at step 828, the application, browser plug-in, or the like reads the response to the user, such as by indicating what is being presented on screen and, optionally, what has changed, as well.

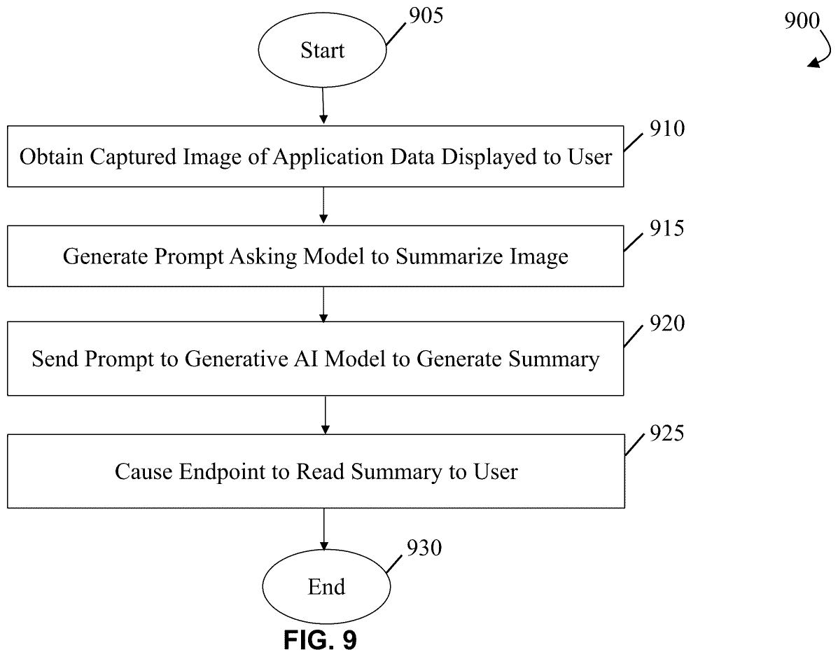

FIG. 9 illustrates an example simplified procedure for providing accessibility to visually impaired users of dynamic applications, in accordance with one or more implementations described herein. For example, a non-generic, specifically configured device (e.g., device 200), may perform procedure 900 (e.g., a method) by executing stored instructions (e.g., AI process 248 and/or accessibility process 249). The procedure 900 may start at step 905, and continues to step 910, where, as described in greater detail above, the device (e.g., a controller, server, etc.) may obtain a captured image of application data displayed by an application to a user via an electronic display of an endpoint operated by the user. In some implementations, the application data comprises a dynamic webpage displayed to the user. In one implementation, the captured image is captured by a browser plug-in.

At step 915, as detailed above, the device may generate a prompt for input to a generative artificial intelligence model that asks the generative artificial intelligence model to summarize the captured image. In some implementations, the generative artificial intelligence model comprises a multimodal large language model (LLM). In some cases, the device may also determine whether the captured image is a duplicate of a previously captured image from the endpoint, prior to generating the prompt. In one implementation, the device is configured to discard duplicate images captured by the endpoint. In a further implementation, the device determines whether any differences between the captured image and a previously captured image from the endpoint exceed a predefined threshold. In one implementation, the device is configured to discard images captured by the endpoint that do not differ from their prior images by the predefined threshold.

At step 920, the device may send the prompt to the generative artificial intelligence model, to generate a summary of the captured image, as described in greater detail above. In various implementations, the device may do so by sending at least one image that was captured prior to that of the captured image to the generative artificial intelligence model in conjunction with the prompt, wherein the summary includes a description of a visual change between the at least one image and the captured image.

At step 925, as detailed above, the device may cause the endpoint operated by the user to read the summary of the captured image to the user. In some implementations, the summary comprises an audio file that the endpoint plays to the user to read the summary to them.

Procedure 900 may then end at step 930.

It should be noted that while certain steps within procedure 900 may be optional as described above, the steps shown in FIG. 9 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that allow for providing accessibility to visually impaired users of dynamic applications, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method, comprising:
obtaining, by a device, a captured image of application data displayed by an application to a user via an electronic display of an endpoint operated by the user;
generating, by the device, a prompt for input to a generative artificial intelligence model that asks the generative artificial intelligence model to summarize the captured image;
sending, by the device, the prompt to the generative artificial intelligence model, to generate a summary of the captured image; and
causing, by the device, the endpoint operated by the user to read the summary of the captured image to the user.

2. The method as in claim 1, wherein the application data comprises a dynamic webpage displayed to the user.

3. The method as in claim 1, wherein the captured image is captured by a browser plug-in.

4. The method as in claim 1, wherein the generative artificial intelligence model comprises a multimodal large language model (LLM).

5. The method as in claim 1, wherein sending the prompt to the generative artificial intelligence model further comprises:
sending at least one image that was captured prior to that of the captured image to the generative artificial intelligence model in conjunction with the prompt, wherein the summary includes a description of a visual change between the at least one image and the captured image.

6. The method as in claim 1, further comprising:
determining whether the captured image is a duplicate of a previously captured image from the endpoint, prior to generating the prompt.

7. The method as in claim 6, wherein the device is configured to discard duplicate images captured by the endpoint.

8. The method as in claim 1, further comprising:
determining whether any differences between the captured image and a previously captured image from the endpoint exceed a predefined threshold.

9. The method as in claim 8, wherein the device is configured to discard images captured by the endpoint that do not differ from their prior images by the predefined threshold.

10. The method as in claim 1, wherein the summary comprises an audio file that the endpoint plays to the user to read the summary to them.

11. An apparatus, comprising:
one or more network interfaces;
a processor coupled to the one or more network interfaces and configured to execute one or more processes; and
a memory configured to store a process that is executable by the processor, the process when executed configured to:
obtain a captured image of application data displayed by an application to a user via an electronic display of an endpoint operated by the user;
generate a prompt for input to a generative artificial intelligence model that asks the generative artificial intelligence model to summarize the captured image;
send the prompt to the generative artificial intelligence model, to generate a summary of the captured image; and
cause the endpoint operated by the user to read the summary of the captured image to the user.

12. The apparatus as in claim 11, wherein the application data comprises a dynamic webpage displayed to the user.

13. The apparatus as in claim 11, wherein the captured image is captured by a browser plug-in.

14. The apparatus as in claim 11, wherein the generative artificial intelligence model comprises a multimodal large language model (LLM).

15. The apparatus as in claim 11, wherein the apparatus sends the prompt to the generative artificial intelligence model further by:
sending at least one image that was captured prior to that of the captured image to the generative artificial intelligence model in conjunction with the prompt, wherein the summary includes a description of a visual change between the at least one image and the captured image.

16. The apparatus as in claim 11, wherein the process when executed is further configured to:
determine whether the captured image is a duplicate of a previously captured image from the endpoint, prior to generating the prompt.

17. The apparatus as in claim 16, wherein the apparatus is configured to discard duplicate images captured by the endpoint.

18. The apparatus as in claim 11, wherein the process when executed is further configured to:
determine whether any differences between the captured image and a previously captured image from the endpoint exceed a predefined threshold.

19. The apparatus as in claim 18, wherein the apparatus is configured to discard images captured by the endpoint that do not differ from their prior images by the predefined threshold.

20. A tangible, non-transitory, computer-readable medium storing program instructions that cause a device to execute a process comprising:
obtaining, by the device, a captured image of application data displayed by an application to a user via an electronic display of an endpoint operated by the user;
generating, by the device, a prompt for input to a generative artificial intelligence model that asks the generative artificial intelligence model to summarize the captured image;
sending, by the device, the prompt to the generative artificial intelligence model, to generate a summary of the captured image; and
causing, by the device, the endpoint operated by the user to read the summary of the captured image to the user.
